(19) United States
(12) Patent Application Publication
(10) Pub. No.: US 2003/0194502 A1
(43) Pub. Date: Oct. 16, 2003

(54) Process for coating a concrete surface

(76) Inventor: Gerald W. Sadleir, Santee, CA (US)

Correspondence Address: Averill & Varn, 8244 Painter Ave., Whittier, CA, 90602, US

(21) Appl. No.: 10/120,657

(22) Filed: Apr. 12, 2002

(51) Int. Cl. B05D 1/02; C04B 24/24

(52) U.S. Cl. 427/427; 106/724; 106/823; 524/5

(57) ABSTRACT

A process for covering a concrete surface with a cementitious coating. Portland cement is mixed with a polymer containing ethylene-vinyl acetate co-polymer and vinyl acetate monomer with water to form a cementitious mixture with a paint-like viscosity. This paint-like product is placed in a paint spray pressure pot and sprayed using a paint gun with a special spray tip to coat concrete and other substrate surfaces with a natural or integrally colored thin layered cement finish surface to be coated. The result is a surface that is free of stains, spots and discolorations, but with a concrete rather than a paint-like appearance.

### FIELD OF THE INVENTION

The field of the invention is concrete coating and the invention relates more particularly to the resurfacing of existing concrete surfaces.

### BACKGROUND OF THE INVENTION

Various concrete paints are known which are sprayed or rolled on the upper surface of concrete walkways, driveways, and the like to improve the appearance thereof. Epoxy-type coatings are well known and provide a relatively high level of durability, but suffer from a variety of shortcomings. Being visibly and chemically unlike concrete, any paint-type of coating can chip or peel from the surface after time. A thin cementitious surface coating is described in U.S. Pat. No. 5,599,634 which uses a cement and filler mixture combined with excess water, as compared to that amount of water which would be used to make concrete. The very high water content mixture is brushed, rolled or sprayed, or mortar floated, or troweled on the top of an existing cement surface. The base concrete de-waters the excess water from the thin cementitious mixture. The compacted material then matures as a coating bonded to the concrete surface. Fillers between the ratio of 1-1 and 3-1 are suggested.

### BRIEF SUMMARY OF THE INVENTION

The present invention is for a process for covering a concrete surface with a cementitious coating. The process involves mixing 100 parts of Portland cement with between 15-30 parts of a polymer containing ethylene-vinyl acetate co-polymer and vinyl acetate monomer with about 50-70 parts of water to form a cementitious mixture with a paint-like viscosity. This mixture is then placed in a paint spray pressure pot and sprayed using a paint gun with a specially designed spray gun onto the surface of concrete to be coated. The mixture is allowed to cure to provide a coated concrete surface. Preferably, the surface is sprayed with a concrete sealer after the concrete surface has cured.

### DESCRIPTION OF THE PREFERRED EMBODIMENTS

Concrete driveways and walkways often become stained or discolored by various means. Oil leaks provide a common staining element for driveways. Also, designs or letterings which have been painted onto the concrete surface may have faded or chipped to result in an unsightly appearance of the concrete surface. Also, thin cracks often exist which are unsightly. Furthermore, it is often desired to add a decorative feature or finish to an existing concrete surface.

The present invention is a formulation which is provided in a dry form and is prepared for use by just adding water and stirring. When water is added to the dry powder mix, a new flexible adhesive cementitious compound is created which can be used to restore stained, discolored, or faded concrete to a like-new condition. While the product is not a paint, it is formulated so that it may be applied like a paint. It provides a uniform cement finish in a natural cement color or any integral color desired. It increases the resistance to water, salt damage, abrasion, freeze-thaw, fading and chemical attack as compared to the existing concrete surface. It bonds tenaciously to concrete or masonry floors and walls, foam and many other surfaces. It is preferably sealed with a sealant prior to the opening of traffic or before allowing water to contact its surface to prevent staining.

The dry mix used to make the coating of the present invention has 100 parts by weight of Portland cement, from 1-2 parts by weight of ethylene-vinyl acetate co-polymer, from 20-21 parts by weight of vinyl acetate monomer and from 71-82 parts by weight of water.

The coating of the present invention has many uses and applications. It can be sprayed in a thin layer over broom-finished, stamped, or hand-troweled finished concrete, to fix color problems, or to change a color and provide a more uniform appearance without changing an existing texture. It preserves texture. Unlike paint, it can be antiqued and colored with acid stains, dyes, antiquing powders and other materials to create a variety of decorative finishes. The coating can also be used to create borders, logos and designs by spraying it over templates or stencils to achieve a decorative raised appearance. It covers non-moving shrinkage cracks in concrete floors and tilt-up walls and can be used for coating foam shapes and many other applications.

The dry powder mix which is to be mixed with water for application is made by mixing 100 parts by weight of Portland cement, between 15-30 parts by weight of a dry polymer containing ethylene-vinyl acetate co-polymer and vinyl acetate monomer is mixed with the cement.

To form the final liquid coating, between 50-80 parts by weight of water are added to the dry powder mix and mixed to form a cementitious mixture with a paint-like viscosity. The term “paint-like viscosity” is intended to mean a viscosity similar to that found in normal ready-to-apply house paint. The mixed product is placed into a paint spray pressure pot and sprayed, using a special spray gun, onto the surface of the concrete to be coated. The special gun differs from a standard paint spray gun in the following particulars: The spray un used to apply spray top has a larger tip size, a larger needle, and a heavier duty spring (that fits over the needle) compared to spray guns used to apply standard household and commercial paints. These parts are commercially available.

The surface must be clean and sound, free from dirt, oil, sealers, waxes, curing agents, or any other contaminants that may interfere with bonding. When applying the coating over an existing sealer, it is necessary to apply a prime coat, such as a clear water base epoxy. Typically, a concrete surface would be scrubbed with a detergent to loosen up dirt and oil, using a floor scrubbing machine with the proper scrub brush attachment and quickly rinsing, using a 3000 psi pressure washer. Next, the surface is acid washed with four parts of water to one part of muriatic acid to lightly etch the surface. The surface to be acid washed must be damp with water prior to applying acid and the surface should be maintained in a wet condition until the acid is neutralized and rinsed. The acid is neutralized, preferably with ten parts of water with one part of ammonia using a pump-up sprayer. The acid washed and neutralized surface is then pressure washed at close range to clean and rinse the surface.

The mixed coating covers about 75 to 200 square feet per gallon of coating, depending on the thickness applied. If any color is desired, it can be mixed in with the dry powder mix prior to adding water, or after adding water, preferably using a drill motor and mixing paddle. In hot climates or for applications expected to take a relatively long period of time, a retarder may be added to the mix to retard the curing of the cement/polymer-containing coating. Additional water can also be added to thin the mix if it has become too thick to spray.

Paint sprayers useful with the process of the present invention include conventional paint pressure pot sprayers, airless sprayers, and HVLP sprayers.

Before applying the coating with a conventional pressure pot compressor and spray gun, it is preferred that water be added to the pressure pot to wet the insides of the fluid hose. Next, the water is removed and the cementitious coating is placed in the pressure pot and the air pressure from the pressure pot to the spray gun is set between 40 and 50 psi maximum. Any excess water is sprayed out of the hose into a bucket until the coating starts to come through the spray gun. The coating is then sprayed onto the prepared surface of the concrete. It is sprayed out of the spray gun as paint would be applied to achieve the desired finish. The spray gun can be adjusted to apply a very thin-like air brush coat or a thicker coating up to 1/16th of an inch in one application.

After the coating has cured and before opening the coated surface to traffic, or before allowing water to contact the surface, a concrete sealer should be sprayed on the cured cementitious coating.

The coating can not only be applied on cleaned and etched concrete surfaces, but it can also be applied on other surfaces, such as foam, linoleum, and tile. On such surfaces, it is often beneficial to apply a prime coat of epoxy clear prior to the coating of the surface with the formulated mix of the present invention.

Because of the presence of the polymer, the coating of the present invention creates a tenacious bond to concrete and other substitute surfaces. It does not rely on the absorption of water from the coating to create a bond, since it will bond to an epoxy coated surface. The result is a concrete surface with a controlled uniform color of the same appearance and surface reflective nature as professionally finished concrete and unlike the glossy appearance of paint.

The present embodiments of this invention are thus to be considered in all respects as illustrative and not restrictive; the scope of the invention being indicated by the appended claims rather than by the foregoing description. All changes which come within the meaning and range of equivalency of the claims are intended to be embraced therein.

I claim:

1. A process for covering a concrete surface with a cementitious coating comprising:
mixing 100 parts by weight of Portland cement and from 15 to 30 parts by weight of a polymer containing ethylene-vinyl acetate co-polymer and vinyl acetate monomer with about 50 to 70 parts by weight of water to form a cementitious mixture with a paint-like viscosity;
placing the cementitious mixture in a paint spray pressure pot;
spraying the cementitious mixture on the concrete surface to be coated; and
allowing the cementitious mixture to cure to provide a coated concrete surface.

2. The process of claim 1 wherein said polymer comprises from 6 to 10% by weight of ethylene-vinyl acetate copolymer and the balance of vinyl acetate monomer.

3. The process of claim 1 wherein said polymer is added in an amount from about 20 to 25 parts per 100 parts by weight of Portland cement.

4. The process of claim 1 further including the step of spraying a concrete sealer onto said coated concrete surface.

5. The process of claim 1 further including the step of acid washing the concrete surface prior to said spraying step.

6. A concrete coating comprising:
100 parts by weight of Portland cement;
from 1 to 2 parts by weight of ethylene-vinyl acetate co-polymer;
from 20 to 21 parts by weight of vinyl acetate monomer; and
from 71 to 82 parts by weight of water.
